(19) United States
(12) Patent Application Publication
(10) Pub. No.: US 2007/0140353 A1
(43) Pub. Date: Jun. 21, 2007

(54) Intra prediction skipping in mode selection for video compression

(75) Inventor: Shijun Sun, Vancouver, WA (US)

Correspondence Address: MARGER JOHNSON & MCCOLLOM, P.C., 210 SW MORRISON STREET, SUITE 400, PORTLAND, OR, 97204, US

(73) Assignee: Sharp Laboratories of America, Inc., Camas, WA (US)

(21) Appl. No.: 11/313,074

(22) Filed: Dec. 19, 2005

(51) Int. Cl. H04N 11/04; H04N 7/12

(52) U.S. Cl. 375/240.24; 375/240.26

(57) ABSTRACT

Video compression wherein intra mode selection is accelerated by examining the coding mode of neighboring blocks: With respect to a macroblocks in a P picture, the following macroblocks are examined to determine whether or not the intra mode calculations for a particular macroblock can be skipped: a) The neighboring macroblock above the particular macroblock. b) The neighboring macroblock to the left of the particular macroblock. c) The collocated macroblock in the first available reference picture. d) The neighboring macroblock below the collocated macroblock in the first available reference picture. e) The neighboring macroblock to the right of the collocated macroblock in the first available reference picture. With respect to macroblocks in a B picture, the following blocks are examined to determine whether or not the intra mode calculations for a particular macroblock can be skipped: a) The collocated macroblock in the first available forward reference picture. b) The collocated macroblock in the first available backward reference picture.

### FIELD OF THE INVENTION

The present invention relates to data compression and more particularly to the compression of video data.

### BACKGROUND

Video compression can be achieved by using temporal compression (that is, inter picture compression) or by spatial compression (that is, intra picture compression).

Inter picture compression takes advantage of the redundancy in a series of pictures. That is, inter picture compression is achieved by computing some pictures from other pictures.

Intra picture compression removes redundant data within an individual picture. If there is less detail in a picture, intra compression is better able to generalize the picture and reduce the size. Intra compression divides a picture into blocks and attempts to compress each block. The size of the blocks into which a picture is divided is very important with respect to intra compression. In order to achieve the highest compression some intra compression techniques examine the compression that can be achieved with various size blocks. For example, a compression techniques may first divide pictures into 16×16 macroblocks, and then determine the best intra compression that can be achieved based on sub-blocks having sizes of 8×16, 16×8, 8×8, 8×4, 4×8, 4×4, etc. The best block size for a particular image region depends upon the particular content of that region.

Three different types of pictures are usually defined for use in picture compression. The three types of pictures are generally referred to as I pictures, P pictures and B pictures. I pictures are fully coded pictures or images. P pictures are pictures that are predicted from previous pictures. B pictures are bidirectional pictures that can be constructed from either I pictures or P pictures in a forward or reverse direction.

A relatively new compression standard is the H.264 compression standard. The H.264 compression standard defines a new generation of video compression technology that can provide more than twice the coding efficiency of previous video coding standards. That is, using the H.264 technology a video file of equal visual quality can be less than half the size of a file generated using the technology of previous compression standards.

The H.264 standard is defined in documents published by the International Telecommunication Union (herein referred to as the ITU) and by the International Standard Organization (herein referred to as the ISO). The ITU-T H.264 standard and the ISO/IEC MPEG-4 Part 10 standard (formally, ISO/IEC 14496-10) are technically identical. It is noted that the H.264 compression technology is also sometimes referred to by names such as (a) Advanced Video Coding or AVC, (b) the MPEG-4 Part 10A standard, (c) the H.264/AVC standard, (d) the AVC/H.264 standard, (e) the H.264/MPEG-4 AVC standard, (f) the MPEG-4/H.264 AVC standard, etc.

The H.264 compression standard is described and defined, among other places, in the following three documents: (1) ITU-T Rec. H.264, (2) ISO/IEC 14496-10, (3) ISO/IEC 14496-10/FDAM1. Copies of the above three documents are publicly available and they can be obtained from ITU and ISO and they are hereby incorporated herein in their entirety for the purpose of reference.

Mode selection is a key activity in compression systems, such as the H.264 system, that utilize both inter picture and intra picture compression. A significant amount of time and computation is required to determine if a block should be intra coded or inter coded. Furthermore, in some systems there are multiple intra block prediction modes that need to be considered. For example, in H.264 system, there are nine intra prediction modes for each 4 by 4 image block and four intra prediction modes for each 16 by 16 block. A significant amount of time is required to determine the amount of compression that could be achieved with each of these modes.

Techniques have been proposed to simplify the intra mode prediction process. One such method is described in an article entitled “Fast Mode Decision for Intra Prediction” JVT-G013, March 2003 by Pan et al. Approximately sixty percent of the computation time can be saved utilizing the techniques described in the Pan article. However, further improvements in the decision process are desirable.

### SUMMARY OF THE PRESENT INVENTION

With the present invention the intra mode selection process is accelerated by examining the coding mode of neighboring blocks and skipping the calculations for intra mode selection under certain conditions. The intra mode selection calculations are skipped based upon the coding mode of neighboring blocks.

With respect to a macroblocks in a P picture, some or all of the following macroblocks are examined to determine whether or not the intra mode calculations for a particular macroblock can be skipped:
a) The neighboring macroblock above the particular macroblock.
b) The neighboring macroblock to the left of the particular macroblock.
c) The collocated macroblock in the first available reference picture.
d) The neighboring macroblock below the collocated macroblock in the first available reference picture.
e) The neighboring macroblock to the right of the collocated macroblock in the first available reference picture.
   With respect to macroblocks in a B picture, one or both of the following blocks are examined to determine whether or not the intra mode calculations for a particular macroblock can be skipped:
a) The collocated macroblock in the first available forward reference picture.
b) The collocated macroblock in the first available backward reference picture.

### BRIEF DESCRIPTION OF THE FIGURES

FIG. 1 is an overall system diagram.

FIG. 2 is an overall flow diagram

FIG. 3A is a diagram showing macroblocks in a P picture and in a reference picture.

FIG. 3B is a diagram showing macroblocks in a B picture and in a reference picture.

### DETAILED DESCRIPTION

Several preferred embodiments of the present invention will now be described with reference to the accompanying drawings. Various other embodiments of the invention are also possible and practical. This invention may be embodied in many different forms and the invention should not be construed as being limited to the embodiments set forth herein.

The figures listed above illustrate a preferred embodiment of the invention and the operation of such embodiment. In the figures, the size of the boxes is not intended to represent the size of the various physical components. Were the same element appears in multiple figures, the same reference numeral is used to denote the element in all of the figures where it appears.

Only those parts of the various units are shown and described which are necessary to convey an understanding of the embodiment to those skilled in the art. Those parts and elements not shown are conventional and known in the art.

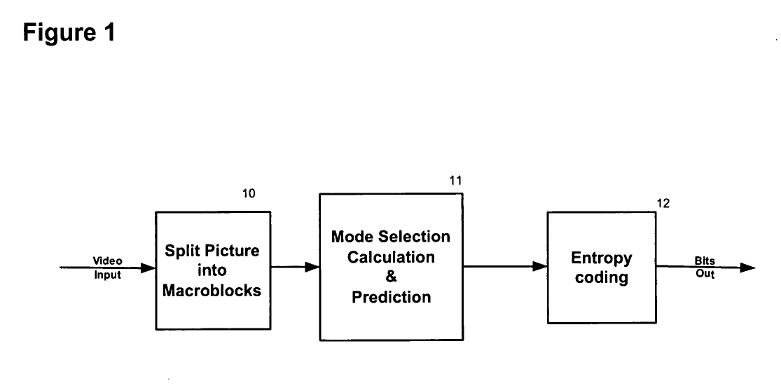

FIG. 1 shows an overall system diagram of a video image compression system. The video input pictures are first split into macroblocks by unit 10. Next, mode selection unit 11 performs various calculations and predictions to determine the most advantageous compression mode. Finally unit 12 does the appropriate coding.

The system shown in FIG. 1 utilizes a technique known as rate distortion optimization (RDO). RDO maximizes coding quality and it minimizes the size of the resulting data by exhaustively examining various different intra and inter prediction modes. For example, the H.264 protocol utilizes RDO, and with the H.264 protocol, the mode selection can consider nine possible 16 by 16 intra modes and four 4×4 intra modes. The calculations for each of these possible modes require a significant amount of time. The present invention is directed to decreasing the amount of processing required for mode selection.

Each macroblock can be compressed in either an intra mode or an inter mode. The present invention provides a technique for eliminating a substantial amount of the computations required with respect to intra mode prediction. With the present invention, the computations associated with intra mode prediction can be skipped for certain macroblocks in P and B pictures. With respect to I pictures all macroblocks are intra compressed as is conventional.

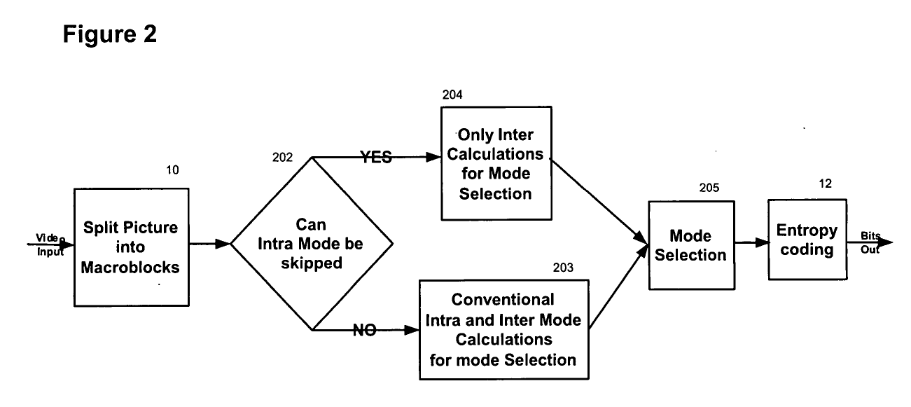

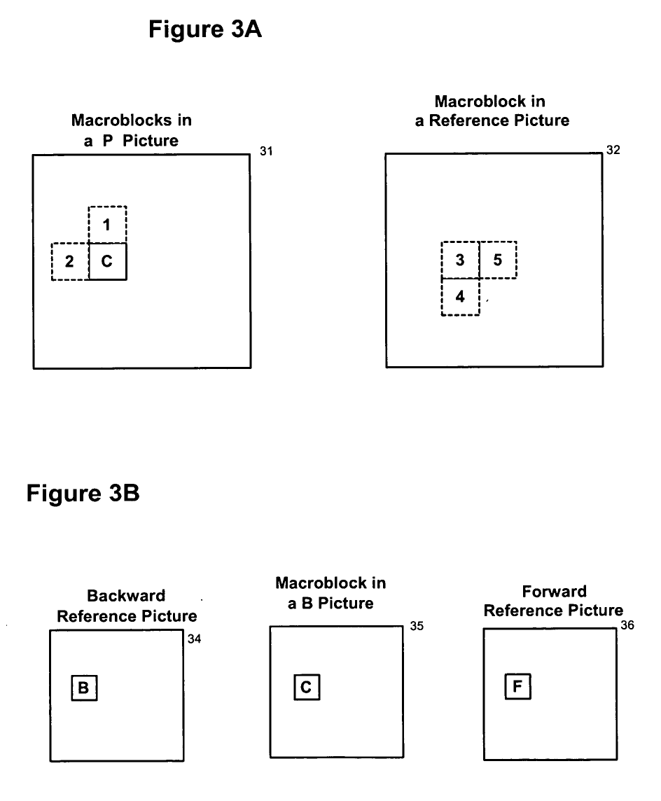

FIG. 2 shows an outline of the process that takes place with respect to macroblocks in P and B pictures. The operations indicated by blocks 202 to 205 take place with respect to each macroblock in each P and B picture. First, a determination is made by block 202 as to whether or not the intra mode calculations and predictions can be skipped for the particular macroblock being processed. How the determination is made as to whether or not the intra mode calculations can be skipped is illustrated in FIGS. 3A and 3B and it will be explained later.

If the intra mode calculations can be skipped, the process proceeds immediately to the inter mode calculations as indicated by block 204 and the inter mode calculations are made in a conventional manner. If the intra mode calculations cannot be skipped, both the intra and inter mode calculations are made in a conventional manner as indicated by block 203.

FIG. 3A illustrates the process used to determine if intra mode calculations can be skipped when processing macroblocks in P pictures. FIG. 3B illustrates the process used to determine if intra mode calculations can be skipped when processing macroblocks in B pictures.

Both FIG. 3A and FIG. 3B illustrate a picture and they show a particular macroblock, designated C, which is currently being processed. FIG. 3A also shows five other macroblocks in dotted lines. The macroblocks shown in dotted lines are designated by the numbers “1” to “5”. The macroblocks “1” to “5” are the macroblocks that are considered when deciding whether or not intra mode processing can be skipped for a current macroblock “C”.

In the particular embodiment shown herein, processing for a particular macroblock “C” in a “P’ picture can be skipped if all of the following macroblocks have been inter coded (See FIG. 3A):
a) The neighboring macroblock above the particular macroblock, that is, the macroblock designated by the numeral “1”.
b) The neighboring macroblock to the left of the particular macroblock, that is, the macroblock designated by the numeral “2”.
c) The collocated macroblock in the first available reference picture, that is, the macroblock designated by the numeral “3”.
d) The neighboring macroblock below the collocated macroblock in the first available reference picture, that is, the macroblock designated by the numeral “4”.
e) The neighboring macroblock to the right of the collocated macroblock in the first available reference picture, that is, the macroblock designated by the numeral “5”.
   With respect to macroblocks in a B picture, in the particular embodiment shown here both of the following macroblocks are examined to determine whether or not a particular macroblock needs to be intra compressed (see FIG. 3B):
a) The collocated macroblock in the first available forward reference picture.
   That is the macroblock designated F in FIG. 3B.
b) The collocated macroblock in the first available backward reference picture.
   That is the macroblock designated B in FIG. 3B.

Using the criteria described above the intra coding can be skipped or eliminated for some macroblocks. This decreases the amount of time required for mode selection. Once a determination has been made that intra coding can be skipped for a particular macroblock, the mode selection process can continue in a conventional manner except that the time required for intra mode calculation can be eliminated.

Motion estimation is the main bottleneck in many video coding systems. The use of fast motion estimation techniques can eliminate or minimize motion estimation as a bottleneck. However, when fast motion estimation techniques are used, the time required for other calculations, such as the calculations required for intra compression become more important and critical.

In systems that use advanced protocols, such as H.264, the intra mode selection process is complex and time consuming. For example with H.264, there are nine possible intra prediction modes for a 4 by 4 block and four possible prediction modes for a 16 by 16 block. The calculation associated with each of these prediction modes becomes very time consuming. With the present invention, these calculations are eliminated for some macroblocks.

In many systems, most macroblocks in the P and B pictures are coded using inter predictions instead of intra predictions. Therefore, statistically, there is little or no degradation if the intra coding is skipped for the blocks that are inter coded. However, it is not possible to determine if a block will be inter coded until all the coding options have been calculated and predicted. The present invention in essence makes a “guess” or “prediction” as to whether or not a block will be inter coded by examining the coding of neighboring blocks.

The assumption underlying the present invention is that the coding mode, that is intra or inter, is highly correlated among neighboring picture macroblocks. Thus, by examining the coding mode of neighboring blocks, the present invention determines if intra coding for a particular block can be skipped.

It is noted that (as shown in FIG. 3A) all the macroblocks used in the determination made relative to P pictures are macroblocks that surround the macroblock under consideration plus the co-located macroblock. As is conventional, the macroblocks in a picture are processed from left to right and from top to bottom. Thus, blocks “1” and “2” are blocks in the same picture as the block under consideration that have already been processed. Blocks “3”, “4” and “5” are also macroblocks that have been processed; however, they are in the reference frame. Thus, blocks “1” to “5” are the blocks that most likely have relevant information to indicate if the current macroblock needs to be intra coded.

It is also noted that the macroblocks to the right and underneath macroblock C in the P frame could not be used in determining if macroblock C should be intra coded, since these blocks have not as yet been processed at the time macroblock C is being considered.

The preferred embodiment considers the coding of all the macroblocks “1” to “5” to make a determination as to whether or not macroblock “C” in a P picture needs to be intra coded. However, in other embodiments only some, but not all, of the macroblocks “1” to “5” are considered in order to determine if intra coding for block “C” can be skipped. Such embodiments will operate satisfactorily, but they will not produce results that are as effective as does the preferred embodiment.

Likewise, in the preferred embodiment, the two macroblocks designated “B” and “F” in FIG. 3B are considered in order to determine if macroblock “C” in a B picture should be intra coded. However, in other embodiments only one of the macroblocks “B” or “F” is considered in order to determine if intra coding for macroblock “C” can be skipped. Such embodiments will operate satisfactorily, but they will not produce results that are as effective as does the preferred embodiment.

The preferred embodiment operates in accordance with the H.264 protocol. However, it should be understood that the present invention is applicable to any system that utilizes rate distortion optimization (RDO) and that has both intra and inter coding.

It is noted that herein the term “picture” is used herein as this term is used in the literature relative to video compression. The term frame can be substituted for the term picture. As used herein the term picture is used to mean the same thing as what is referred to as a frame in some literature relative to video compression.

It is noted that the preferred embodiment determines if intra coding can be skipped on a macroblock basis. Protocols such as the H.264 protocol make intra calculation on both a macroblock basis and on the basis of various subdivisions of the macroblock. While the present invention can be used with macroblocks of any reasonable size, the determination of whether intra coding calculations can be skipped is made on a macroblock basis.

While the invention has been shown and described with respect to preferred embodiments thereof, it should be understood that a wide variety of other embodiments are possible without departing from the scope and sprit of the invention. The scope of the invention is only limited by the appended claims.

I claim:

1) In a video compression system that makes compression mode calculations for temporal and spatial compression and where each picture is divided into macroblocks, a method of mode selection that includes skipping the spatial mode compression calculations for a particular macroblock in a predicted picture (P), if the macroblocks surrounding said particular macroblock are temporally coded.

2) The method recited in claim 1 wherein said temporal compression is inter compression and said spatial compression is intra compression.

3) The method recited in claim 1 wherein the spatial mode calculations for said particular macroblock are skipped if some or all of:
a) the neighboring macroblock above the particular macroblock in said P picture,
b) the neighboring macroblock to the left of the particular macroblock in said P picture,
c) the collocated macroblock in the first available reference picture,
d) the neighboring macroblock below the collocated macroblock in the first available reference picture, and
e) the neighboring macroblock to the right of the collocated macroblock in the first available reference picture,
are temporally compressed.

4) The method recited in claim 1 wherein the spatial mode calculations for said particular macroblock are skipped if all of:
a) the neighboring macroblock above the particular macroblock in said P picture,
b) the neighboring macroblock to the left of the particular macroblock in said P picture,
c) the collocated macroblock in the first available reference picture,
d) the neighboring macroblock below the collocated macroblock in the first available reference picture, and
e) the neighboring macroblock to the right of the collocated macroblock in the first available reference picture,
are temporally compressed.

5) The method recited in claim 1 wherein said method utilized the H.264 protocol.

6) The method recited in claim 1 wherein said macroblock is a 16 by 16 macroblock.

7) The method recited in claim 1 wherein said temporal compression generates predicted (P) pictures and bi-directional (B) pictures.

8) A video compression system where each picture is divided into macroblock, said system including,
first means for making compression mode calculations for temporal and spatial compression,
mode selection means responsive to said first mode,
means for skipping the spatial mode compression calculations for a particular macroblock in a predicted picture (P), if the macroblocks surrounding said particular macroblock are temporally compressed.

9) A computer program product recorded on a recordable medium for implementing the system method recited in claim 8.

10) In a video compression system that makes compression mode calculations for a picture based on temporal and spatial compression and where each picture is divided into macroblocks, a method of mode selection that includes skipping the spatial mode compression calculations for a particular macroblock in a bi-directional picture (B), if at least one of the macroblocks collocated with said particular macroblock in a forward or backward reference picture are temporally coded.

11) The method recited in claims 10 wherein the calculations for spatial mode compression for a particular macroblock in a bi-directional picture (B) are skipped if both of the macroblocks collocated with said particular macroblock in a forward and backward reference picture are temporally coded.

12) The method recited in claim 10 wherein said system follows the H.264 protocol.

13) The method recited in claim 10 wherein said macroblocks are 16 by 16 macroblocks.

14) The method recited in claim 10 wherein said temporal compression generates predicted (P) pictures and bi-directional (B) pictures.

15) In a video compression system that makes compression mode calculations for temporal and spatial compression and where each picture is divided into macroblocks, a method of mode selection that includes skipping the spatial mode compression calculations for a particular macroblock based upon the coding of the macroblocks surrounding said particular macroblock and the coding of the macroblocks collocated with said macroblock in reference pictures for said macroblock.

16) The method recited in claim 15 wherein the special compression calculations for a particular macroblock in a P picture are skipped if the macroblocks surrounding said particular macroblock are temporally coded.

17) The method recited in claim 15 wherein the spatial compression calculations for a particular macroblock in a P picture are skipped if some or all of:
a) the neighboring macroblock above the particular macroblock in said P picture,
b) the neighboring macroblock to the left of the particular macroblock in said P picture,
c) the collocated macroblock in the first available reference picture,
d) the neighboring macroblock below the collocated macroblock in the first available reference picture, and
e) the neighboring macroblock to the right of the collocated macroblock in the first available reference picture,
are temporally compressed.

18) The method recited in claim 15 wherein the spatial compression calculations for a particular macroblock in a P picture are skipped if all of:
a) the neighboring macroblock above the particular macroblock in said P picture,
b) the neighboring macroblock to the left of the particular macroblock in said P picture,
c) the collocated macroblock in the first available reference picture,
d) the neighboring macroblock below the collocated macroblock in the first available reference picture, and
e) the neighboring macroblock to the right of the collocated macroblock in the first available reference picture,
are temporally compressed.

19) The method recited in claims 15 wherein the calculations for spatial mode compression for a particular macroblock in a bi-directional picture (B) are skipped if both of the macroblocks collocated with said particular macroblock in a forward and backward reference picture are temporally coded.

20) The method recited in claim 15 wherein the spatial compression calculations for a particular macroblock in a P picture are skipped if all of:
a) the neighboring macroblock above the particular macroblock in said P picture,
b) the neighboring macroblock to the left of the particular macroblock in said P picture,
c) the collocated macroblock in the first available reference picture,
d) the neighboring macroblock below the collocated macroblock in the first available reference picture, and
e) the neighboring macroblock to the right of the collocated macroblock in the first available reference picture,
are temporally compressed and
the calculations for spatial mode compression for a particular macroblock in a bidirectional picture (B) are skipped if both of the macroblocks collocated with said particular macroblock in a forward and backward reference picture are temporally coded.
